(19) United States
(12) Patent Application Publication
(10) Pub. No.: US 2016/0177625 A1
(43) Pub. Date: Jun. 23, 2016

(54) WORKING LADDER

(71) Applicant: Shih-Chieh CHANG, Changhua County (TW)

(72) Inventor: Shih-Chieh CHANG, Changhua County (TW)

(21) Appl. No.: 14/575,521

(22) Filed: Dec. 18, 2014

(51) Int. Cl. E06C 1/18; E06C 1/20

(52) U.S. Cl. CPC E06C 1/18; E06C 1/20

(57) ABSTRACT

A working ladder has a pair of ladder frames and a supporting shaft. The pair of ladder frames are pivotally connected to each other, and each one of the pair of ladder frames has a first side rail, a second side rail, a foot stem and multiple rungs. The first side rail is pivotally connected to the other first side rail. The second side rail is pivotally connected to the other second side rail and is parallel with the first side rail of the ladder frame. The foot stem is adjustably connected to the second side rail and has a connecting end, an abutting end and a fixing segment. The rungs are securely and transversally connected to the first side rail and the second side rail at intervals. The supporting shaft is connected to the pair of ladder frames and has a jointing end and a locating end.

### BACKGROUND OF THE INVENTION

1. Field of the Invention

The present invention relates to a working ladder, and more particularly to a working ladder that can provide a preferred supporting effect in use.

2. Description of Related Art

A conventional working ladder has two ladder frames. The ladder frames are pivotally connected to each other. Each one of the ladder frames has two side rails and multiple rungs. The rungs are transversally connected to the side rails at intervals. In use, a working height of the conventional working ladder can be adjusted by changing an angle between the ladder frames. For example, when the angle between the ladder frames is less than 90 degrees, the side rails of the ladder frames abut on the ground simultaneously, and the conventional working ladder can be used on an occasion with a lower working height. When the ladder frames are moved with an angle of 180 degrees, only one of the ladder frames abuts on the ground, and the conventional working ladder can be used on an occasion with a higher working height.

Although the conventional working ladder has generally been used, the widths of each one of the ladder frames are not wide enough to provide a sufficient lateral supporting effect to the conventional working ladder. Then, the conventional working ladder may dump to have an accident when an external force knocks against a side of the conventional working ladder or the center of gravity of a user is unstable, and this is unsafe in use. Furthermore, when the ground is uneven, the conventional working ladder cannot be securely mounted on the ground and this is also unsafe in use.

Another conventional working ladder has a ladder frame and a supporting shaft. The ladder frame has two side rails. The supporting shaft is pivotally connected to the ladder frame. However, the conventional working ladder can provide a three-positioning effect by the side rails and the supporting shaft. The conventional working ladder only can be used on an occasion with a lower working height and cannot be used on occasion with a higher working height, and this will limit the scope of using the conventional working ladder.

To overcome the shortcomings, the present invention tends to provide a working ladder to mitigate the aforementioned problems.

### SUMMARY OF THE INVENTION

The main objective of the present invention is to provide a working ladder that can provide a preferred supporting effect in use.

The working ladder in accordance with the present invention has a pair of ladder frames and a supporting shaft. The pair of ladder frames are pivotally connected to each other, and each one of the pair of ladder frames has a first side rail, a second side rail, a foot stem and multiple rungs. The first side rail is pivotally connected to the other first side rail. The second side rail is pivotally connected to the other second side rail and is parallel with the first side rail of the ladder frame. The foot stem is adjustably connected to the second side rail and has a connecting end, an abutting end and a fixing segment. The rungs are securely and transversally connected to the first side rail and the second side rail at intervals. The supporting shaft is connected to the pair of ladder frames and has a jointing end and a locating end.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a working ladder in accordance with the present invention;

FIG. 2 is a side view of the working ladder in FIG. 1;

FIG. 3 is a side view in partial section of the working ladder along line 3-3 in FIG. 2;

FIG. 4 is an enlarged perspective view of the working ladder in FIG. 1;

FIG. 5 is an operational perspective view of the working ladder in FIG. 1;

FIG. 6 is an operational side view of the working ladder in FIG. 5;

FIG. 7 is a side view in partial section of the working ladder along line 7-7 in FIG. 6;

FIG. 8 is a perspective view of a second embodiment of a working ladder in accordance with the present invention;

FIG. 9 is an enlarged and exploded perspective view of the working ladder in FIG. 8; and

FIG. 10 is an operational perspective view of the working ladder in FIG. 8.

### DETAILED DESCRIPTION OF THE PREFERRED EMBODIMENT

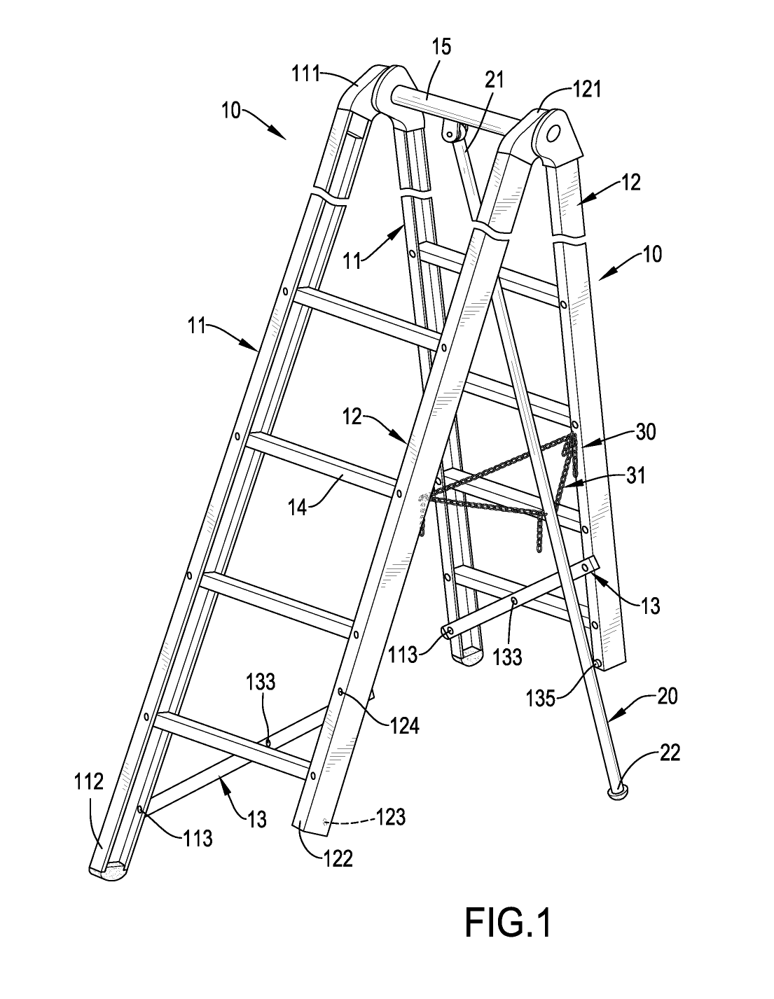

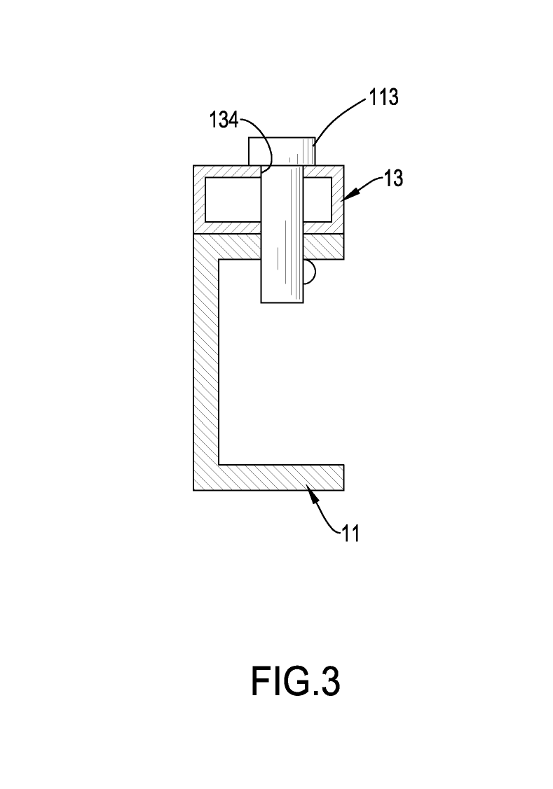

With reference to FIGS. 1 to 3, a first embodiment of a working ladder in accordance with the present invention comprises a pair of ladder frames 10, a supporting shaft 20 and a linking element 30.

The pair of ladder frames 10 are pivotally connected to each other, and each one of the pair of ladder frames 10 has a first side rail 11, a second side rail 12, a foot stem 13 and multiple rungs 14.

The first side rail 11 is pivotally connected to the other first side rail 11 and has a first pivot end 111, a first distal end 112, a first length L1, a side face, an inner side and a locking element 113. The first pivot end 111 of the first side rail 11 is pivotally connected to the first pivot end 111 of the other first side rail 11 by a pivot rod 15 connected to the first pivot ends 111 of the first side rails 11. The first dist end 112 of the first side rail 11 is opposite to the first pivot end 111 of the first side rail 11 and abuts on the ground. The first length L1 of the first side rail 11 is defined between the first pivot end 111 and the first distal end 112 of the first side rail 11. The side face of the first side rail 11 faces the side face of the other first side rail 11. The locking element 113 is connected to the side face of the first side rail 11 adjacent to the distal end 112 of the first side rail 11.

The second side rail 12 is pivotally connected to the second side rail 12 of the other ladder frame 10, is parallel with the first side rail 11 of the ladder frame 10 and has a second pivot end 121, a second distal end 122, a second length L2, a side face, an inner side, a positioning segment 123 and a connecting segment 124. The second pivot end 121 of the second side rail 12 is pivotally connected to the second pivot end 121 of the other second side rail 12 by the pivot rod 15 connected to the second pivot ends 121 of the second side rails 12. The second dist end 122 of the second side rail 12 is opposite to the second pivot end 121 of the second side rail 12. The second length L2 of the second side rail 12 is defined between the second pivot end 121 and the second distal end 122 of the second side rail 11 and is shorter than the first length L1 of the first side rail 11. The side face of the second side rail 12 faces the side face of the other second side rail 12. The inner side of the second side rail 12 faces the inner side of the first side rail 11. The positioning segment 123 may be a hole and is formed in the side face of the second side rail 12 adjacent to the second distal end 122 of the second side rail 12. The connecting segment 124 is formed on the side face of the second side rail 12 adjacent to the positioning segment 123. Preferably, the positioning segment 123 is formed in the side face of the second side rail 12 between the connecting segment 124 and the second distal end 122 of the second side rail 12.

The foot stem 13 is adjustably and pivotally connected to the second side rail 12 and has a connecting end 131, an abutting end 132, a fixing segment 133, a through hole 134 and an inserting pin 135. The connecting end 131 of the foot stem 13 is rotatably connected to the connecting segment 124 of the second side rail 12. The abutting end 132 of the foot stem 13 is selectively connected to the first side rail 11 by the locking element 113. The fixing segment 133 may be a hole and is formed in the foot stem 13 between the connecting end 131 and the abutting end 132 of the foot stem 13.

When the connecting end 131 of the foot stem 13 is rotated relative to the second side rail 12 to enable the fixing segment 133 to align with the positioning segment 123 of the second side rail 12, a position of the foot stem 13 is defined as a first position. In addition, when the connecting end 131 of the foot stem 13 is rotated relative to the second side rail 12 to enable the fixing segment 133 to move away from the positioning segment 123 of the second side rail 12, a position of the foot stem 13 is defined as a second position. The through hole 134 is formed through the abutting end 132 of the foot stem 13 and is connected to the locking element 113. The inserting pin 135 is mounted in ad extend out of the positioning segment 123 of the second side rail 12 and is selectively mounted through the fixing segment 133 of the foot stem 13.

The rungs 14 are securely and transversally connected to the side faces of the first side rail 11 and the second side rail 12 at intervals between the pivot ends 111, 121 and the distal ends 112, 122 of the side rails 11, 12.

The supporting shaft 20 is connected to the pair of ladder frames 10 and has a jointing end 21 and a locating end 22. The jointing end 21 of the supporting shaft 20 is pivotally connected to the pivot rod 15 at a middle of the pivot rod 15 between the side rails 11, 12 of the pair of ladder frames 10. The locating end 22 of the supporting shaft 20 is opposite to the jointing end 21 of the supporting shaft 20 and selectively abuts on the ground. When the supporting shaft 20 is rotated relative to the pair of ladder frames 10 to enable the locating end 22 of the supporting shaft 20 to move away from the first distal ends 112 of the first side rails 11 and to locate at a same horizontal plane with the first distal ends 112 of the first side rails 11, and a position of the supporting shaft 20 is defined as a supporting position.

Furthermore, when the supporting shaft 20 is rotated relative to the pair of ladder frames 10 to enable the locating end 22 of the supporting shaft 20 to move between the first distal ends 112 of the first side rails 11 and the second distal ends 122 of the second side rails 12, and a position of the supporting shaft 20 is defined as a storing position. When the supporting shaft 20 is located at the supporting position, the foot stem 13 is located at the second position, and when the supporting shaft 20 is located at the storing position, the foot stem 13 is located at the first position.

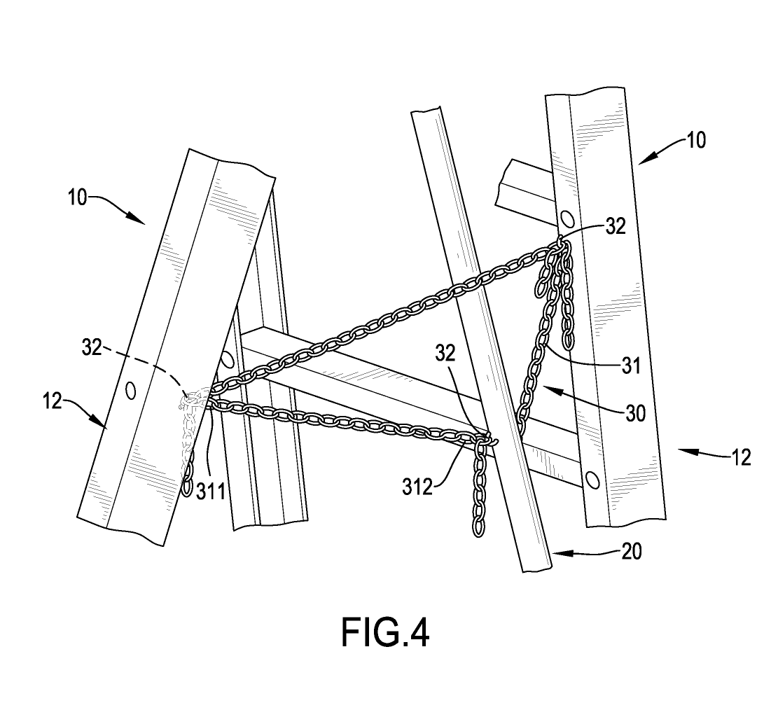

With reference to FIG. 4, the linking element 30 is connected to the pair of ladder frames 10 and the supporting shaft 20 and has at least one flexible component 31 and three hooks 32. The at least one flexible component 31 is connected to the second side rails 12 of the pair of ladder frames 10 and the supporting shaft 20. Preferably, the linking element 30 in the present invention has three flexible components 31, and each one of the flexible components 31 may be a chain that is formed by multiple closed rings connecting to each other and has a fixing end 311 and a hooking end 312. The fixing ends 311 of two of the flexible component 31 are respectively connected to the second side rails 12. The hooking ends 312 of the two flexible components 31 are connected to the supporting shaft 20. The fixing end 311 and the hooking end 312 of the other one flexible component 31 are respectively connected to the second side rails 12. The hooks 32 are respectively mounted on the side faces of the second side rails 12 and an external surface of the supporting shaft 20 and are connected to the at least one flexible component 31.

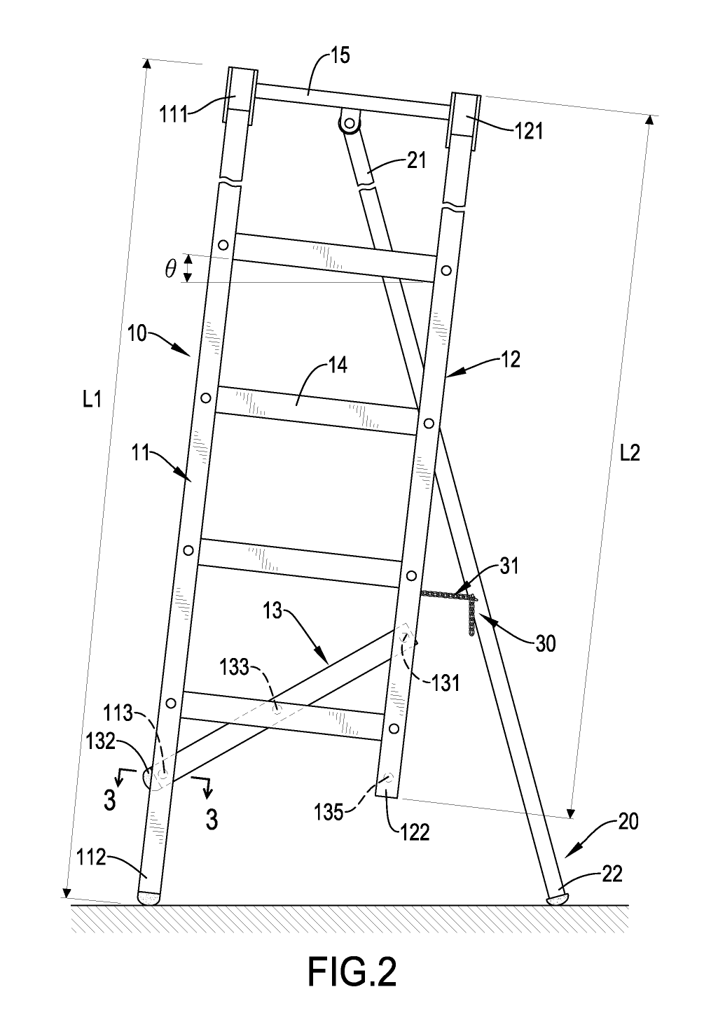

In use, with reference to FIGS. 1 and 2, when the working ladder of the present invention is used on an occasion with a lower working height, the abutting end 132 of the foot stem 13 of each one of the pair of ladder frames 10 is securely mounted on the side face of the first side rail 11 of a corresponding ladder frame 10 by the locking element 113 mounting through the through hole 134 of the foot stem 13 to securely connect the foot stem 13 with the corresponding first side rail 11. Then, the pair of ladder frames 10 are moved relative to each other to enable an angle between the pair of ladder frames 10 to less than 90 degrees, and the locating end 22 of the supporting shaft 20 is moved away from the first distal ends 112 of the first side rails 11 to enable the locating end 22 of the supporting shaft 20 to locate in a same plane with the first distal ends 112 of the first side rails 11. With further reference to FIG. 4, the at least one flexible component 31 are connected to the hooks 32 that are mounted on the second side rails 12 of the pair of ladder frames 10 and the supporting shaft 20 to hold the position of the working ladder.

According to the above-mentioned operation, the plane may be the ground, and that means the locating end 22 of the supporting shaft 20 and the first distal ends 112 of the first side rails 11 abut on the ground simultaneously to provide a three-positioning effect to the working ladder. In addition, with reference to FIG. 2, the pair of ladder frames 10 are obliquely mounted on the ground, and each one of the rungs 14 has an elevation angle θ relative to the ground. Then, the working ladder of the present invention can be securely mounted on the ground by the pair of ladder frames 10, the supporting shaft 20 and the linking element 30. Even if an external force knocks against a side of the working ladder or the center of gravity of a user is unstable, the working ladder will not dumped to have an accident. Furthermore, when the ground is uneven, the three-positioning effect between the pair of ladder frames 10 and the supporting shaft 20 an enable the working ladder to securely mount on the uneven ground with a preferred supporting effect without accidents.

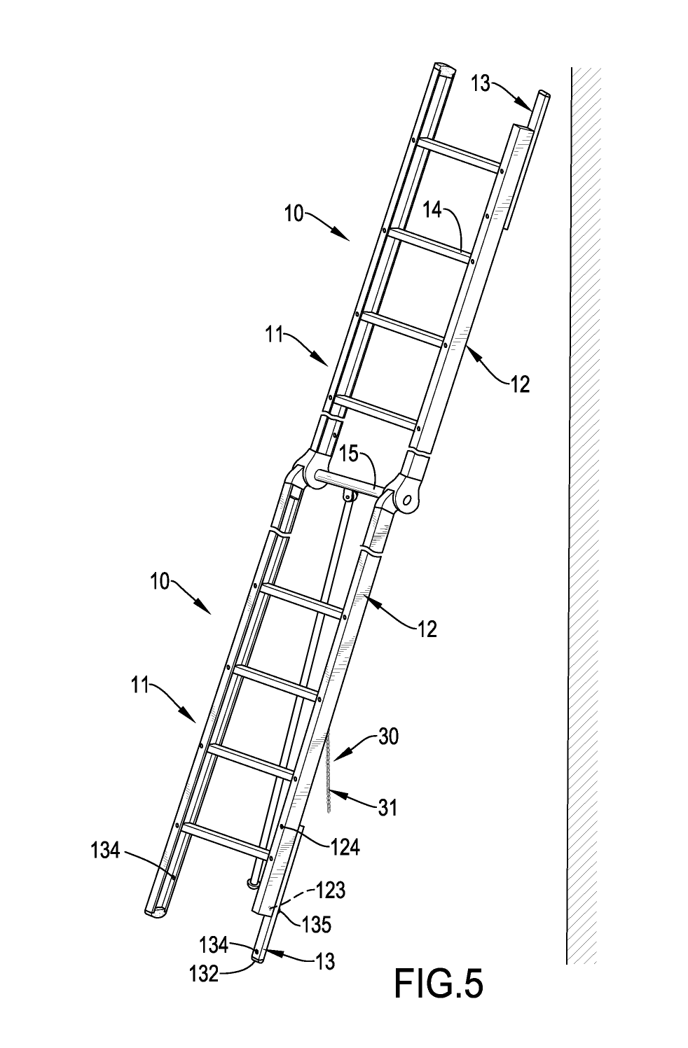

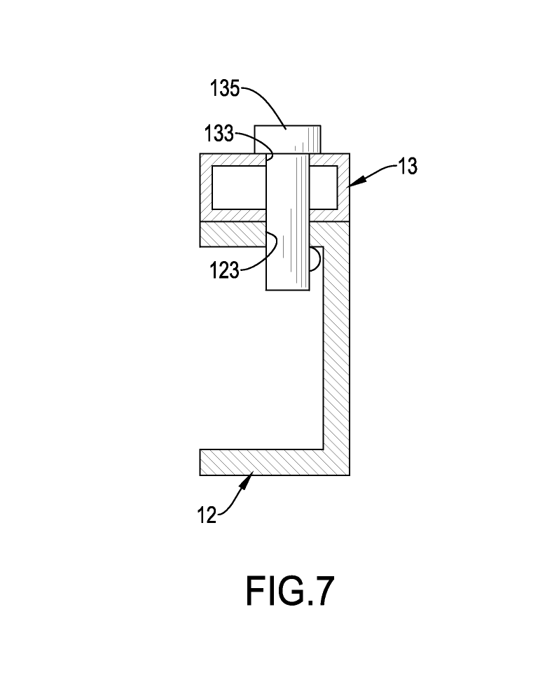

With reference to FIGS. 5, 6 and 7, when the working ladder of the present invention is used on an occasion with a higher working height, the locking elements 113 are separated from the through holes 134 of the foot stems 13 to enable the connecting ends of the foot stems 13 to rotate relative to the connecting segments 124 of the second side rails 12. Then, when the fixing segments 133 of the foot stems 13 respectively align with the positioning segments 123 of the second side rails 12, the inserting pins 135 are connected to the fixing segments 133 and the positioning segments 123 to hold the foot stems 13 securely with the second side rails 12. When the inserting pins 135 are connected to the fixing segments 133 and the positioning segments 123 to hold the foot stem 13 on the first position, the abutting ends 132 of the foot stems 13 respectively extend out of the second distal ends 122 of the second side rails 12, and a total length L between the abutting end 132 of the foot stem 13 and the second pivot end 121 of the corresponding second side rail 12 is equal to the first length L1 of the first side rail 11 between the first pivot end 111 and the first distal end 112 of the first side rail 11.

Then, the pair of ladder frames 10 are moved relative to each other with an angle of 180 degrees and the supporting shaft 20 is moved below the pivot rod 15 between the first distal ends of one of the pair of ladder frames 10. The first distal end 112 and the abutting end 132 of one of the pair of ladder frames 10 abut on the ground, and the other ladder frame 10 abuts a higher working position. Then, the user can operate at the higher working position by using the working ladder of the present invention.

Therefore, the working ladder of the present invention can be used on the occasion with a lower working height by moving the pair of ladder frames 10 with an inverted V-shape and arranging with the supporting shaft 20 as shown in FIGS. 1 and 2 to enable the first distal ends 112 of the first side rails 11 and the locating end 22 of the supporting shaft 20 to abut on the ground to provide a three-positioning effect, and the working ladder can be securely mounted on the ground even if an external force knocks against a side of the working ladder or the center of gravity of a user is unstable.

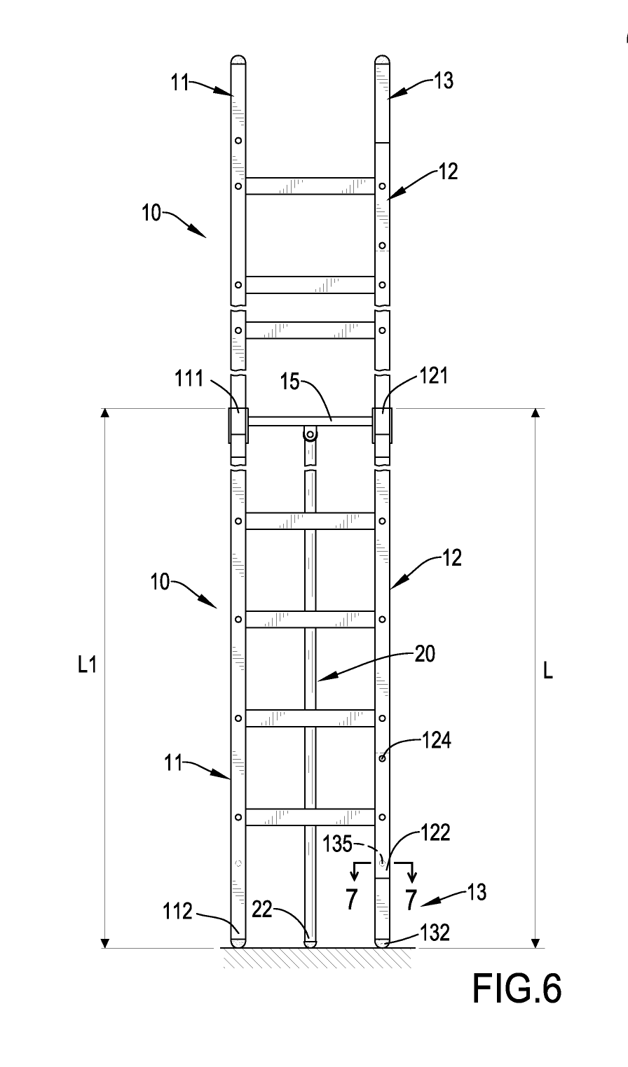

Additionally, the working ladder of the present invention also can be used on the occasion with a higher working height by moving the pair of ladder frames 10 with 180 degrees as shown in FIGS. 5 and 6 to enable the first distal end 112 and the abutting end 132 of one of the pair of ladder frames 10 to abut on the ground and to enable the other ladder frame 10 to abut a higher working position, and this can increase the scope of using the working ladder.

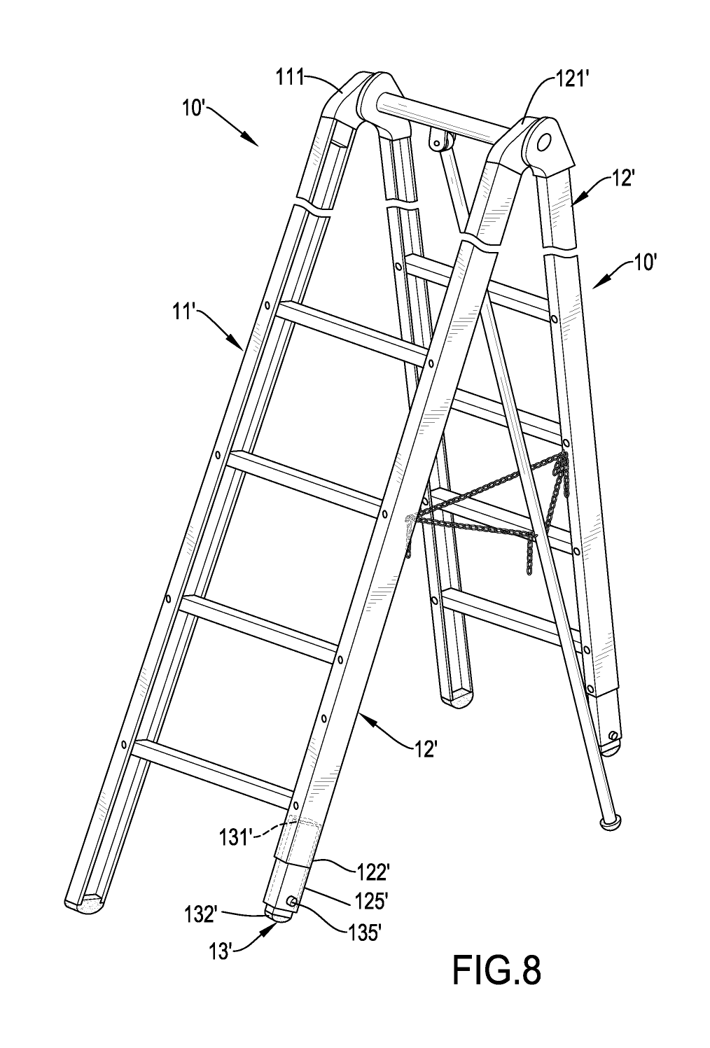

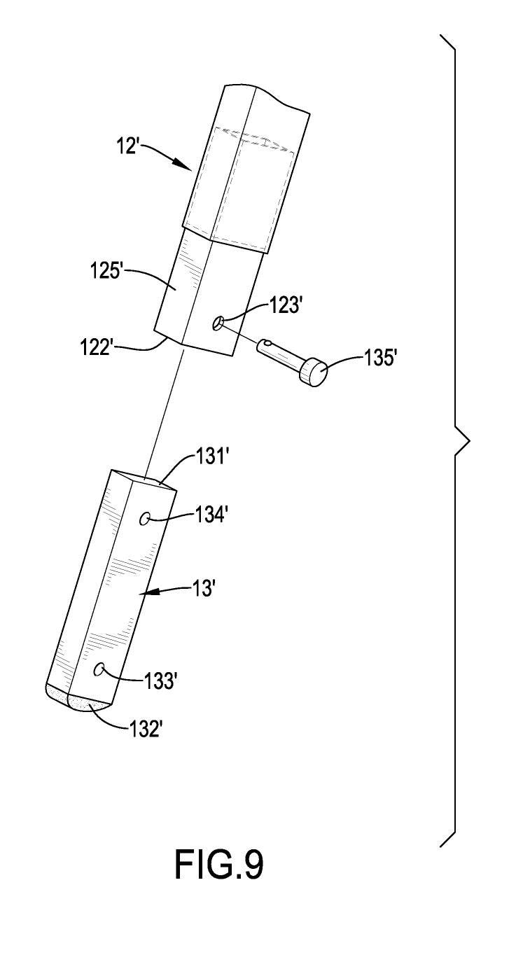

With reference to FIGS. 8, 9 and 10, a second embodiment of a working ladder in accordance with the present invention is substantially the same as the first embodiment except the following features. The first side rail 11′ of each one of the pair of ladder frames 10′ didn't have the locking element 113, and the second side rail 12′ of each one of the pair of ladder frames 10′ further has a mounting tube 125′. The mounting tube 125′ is connected to the second side rail 12′ opposite to the second pivot end 121′ of the second side rail 12′. In addition, the second distal end 122′ and the positioning segment 123′ are formed on the mounting tube 125′.

The foot stem 13′ is slidably connected to the mounting tube 125′ of the second side rail 12′ and has a side face, a connecting end 131′, an abutting end 132′, a fixing segment 133′, an engaging segment 134′ and an inserting pin 135′. The connecting end 131′ of the foot stem 13′ is mounted in the mounting tube 125′ of the second side rail 12′ to enable the side face of the foot stem 13′ to face the positioning segment 123′ of the second side rail 12′. The abutting end 132′ of the foot stem 13′ is formed on the foot stem 13′ opposite to the connecting end 131′ of the foot stem 13′ and selectively abuts on the ground. The fixing segment 133′ is formed in the side face of the foot stem 13′ between the connecting end 131′ and the abutting end 132′ of the foot stem 13′ adjacent to the abutting end 132′ and selectively aligns with the positioning segment 123′ of the second side rail 12′. The engaging segment 134′ is formed in the side face of the foot stem 13′ between the connecting end 131′ and the abutting end 132′ of the foot stem 13′ adjacent to the connecting end 131′ and selectively aligns with the positioning segment 123′ of the second side rail 12′. The inserting pin 135′ is mounted in the positioning segment 123′ of the second side rail 12′ and is selectively mounted in the fixing segment 133′ or the engaging segment 134′ of the foot stem 13′.

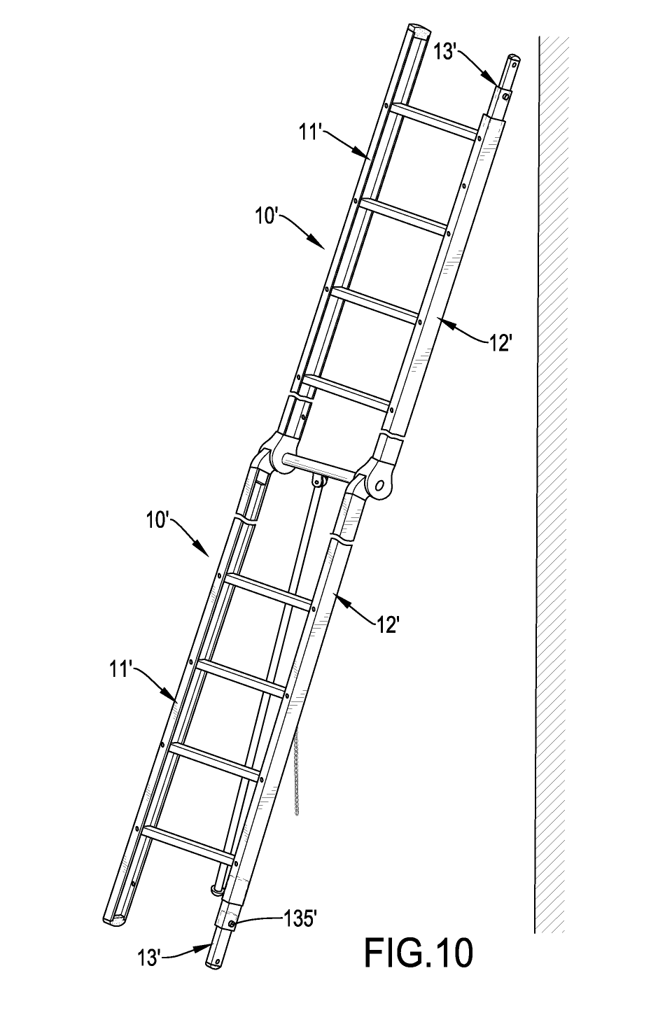

In use, the user can change the position of the inserting pin 135′ relative to the fixing segment 133′ and the engaging segment 134′ of the foot stem 13′ to adjust a length of the foot stem 13′ that extends out of the second side rail 12′ according to the working height. That means, when the second embodiment of the working ladder is used on an occasion with a lower working height, the inserting pin 135′ is mounted in the positioning segment 123′ of the second side rail 12′ and the fixing segment 133′ of the foot stem 13′ as shown in FIG. 8. When the second embodiment of the working ladder is used on an occasion with a higher working height, the inserting pin 135′ is mounted in the positioning segment 123′ of the second side rail 12′ and the engaging segment 134′ of the foot stem 13′ as shown in FIG. 10.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A working ladder having:
a pair of ladder frames pivotally connected to each other, and each one of the pair of ladder frames having
a first side rail pivotally connected to the first side rail of the other one of the pair of ladder frames and having
a first pivot end pivotally connected to the first pivot end of the first side rail of the other one of the pair of ladder frames;
a first distal end being opposite to the first pivot end of the first side rail;
a first length being defined between the first pivot end and the first distal end of the first side rail;
a side face facing the side face of the first side rail of the other one of the pair of ladder frames; and
an inner side;
a second side rail pivotally connected to the second side rail of the other one of the pair of ladder frames, being parallel with the first side rail of the ladder frame and having
a second pivot end pivotally connected to the second pivot end of the second side rail of the other one of the pair of ladder frames;
a second distal end being opposite to the second pivot end of the second side rail;
a second length being defined between the second pivot end and the second distal end of the second side rail and being shorter than the first length of the first side rail;
a side face facing the side face of the second side rail of the other one of the pair of ladder frames;
an inner side facing the inner side of the first side rail; and
a positioning segment formed in the side face of the second side rail adjacent to the second distal end of the second side rail;
a foot stem adjustably connected to the second side rail and having
a connecting end adjustably connected to the second side rail;
an abutting end being opposite to the connecting end; and
a fixing segment formed in the foot stem between the connecting end and the abutting end of the foot stem;
wherein the fixing segment of the foot stem is adjusted to align with the positioning segment of the second side rail, a position of the foot stem is defined as a first position, and a total length between the abutting end of the foot stem and the second pivot end of the second side rail is equal to the first length of the first side rail between the first pivot end and the first distal end of the first side rail; and
wherein the fixing segment of the foot stem is adjusted to move away from the positioning segment of the second side rail, a position of the foot stem is defined as a second position; and
multiple rungs securely and transversally connected to the side faces of the first side rail and the second side rail at intervals between the pivot ends and the distal ends of the side rails; and
a supporting shaft connected to the pair of ladder frames and having
a jointing end pivotally connected to the pair of ladder frames between the side rails of the pair of ladder frames; and
a locating end being opposite to the jointing end of the supporting shaft;
wherein the supporting shaft is rotated relative to the pair of ladder frames to enable the locating end of the supporting shaft to move away from the first distal ends of the first side rails and to locate at a same horizontal plane with the first distal ends of the first side rails, and a position of the supporting shaft is defined as a supporting position;
wherein the supporting shaft is rotated relative to the pair of ladder frames to enable the locating end of the supporting shaft to move between the first distal ends of the first side rails and the second distal ends of the second side rails, and a position of the supporting shaft is defined as a storing position;
wherein the supporting shaft is located at the supporting position, and the foot stem is located at the second position; and
wherein the supporting shaft is located at the storing position, and the foot stem is located at the first position.

2. The working ladder as claimed in claim 1, wherein the connecting end of the foot stem of each one of the pair of ladder frames is pivotally connected to the corresponding second side rail to adjust the foot stem to move at the first position or the second position.

3. The working ladder as claimed in claim 1, wherein
the second side rail of each one of the pair of ladder frames has a mounting tube connected to the second side rail opposite to the second pivot end of the second side rail;
the second distal end and the positioning segment of the second side rail of each one of the pair of ladder frames are formed on the mounting tube of the second side rail;
the connecting end of the foot stem of each one of the pair of ladder frames is slidably connected to the mounting tube of the corresponding second side rail;
the foot stem of each one of the pair of ladder frames has an engaging segment formed in the side face of the foot stem between the connecting end and the abutting end of the foot stem adjacent to the connecting end and aligning with the positioning segment of the corresponding second side rail when the foot stem is located at the second position.

4. The working ladder as claimed in claim 2, wherein the working ladder has a linking element connected to the pair of ladder frames and the supporting shaft, and the linking element has at least one flexible component connected to the supporting shaft and the second side rails when the supporting shaft is located at the supporting position.

5. The working ladder as claimed in claim 3, wherein the working ladder has a linking element connected to the pair of ladder frames and the supporting shaft, and the linking element has at least one flexible component connected to the supporting shaft and the second side rails when the supporting shaft is located at the supporting position.

6. The working ladder as claimed in claim 4, wherein the linking element has
three hooks respectively mounted on the second side rails of the pair of ladder frames and the supporting shaft; and
there flexible components being elongated, and each one of the flexible components having
a fixing end, and the fixing ends of two of the flexible component respectively connected to the second side rails and the fixing end of the other one flexible components connected to one of the second side rails; and
a hooking end, and the hooking ends of the two flexible components connected to the supporting shaft and the hooking end of the other one flexible component connected to the other second side rails.

7. The working ladder as claimed in claim 5, wherein the linking element has
three hooks respectively mounted on the second side rails of the pair of ladder frames and the supporting shaft; and
there flexible components being elongated, and each one of the flexible components having
a fixing end, and the fixing ends of two of the flexible component respectively connected to the second side rails and the fixing end of the other one flexible component connected to one of the second side rails; and
a hooking end, and the hooking ends of the two flexible components connected to the supporting shaft and the hooking end of the other one flexible component connected to the other second side rails.

8. The working ladder as claimed in claim 6, wherein each one of the flexible components of the linking element is formed by multiple closed rings connecting to each other.

9. The working ladder as claimed in claim 7, wherein each one of the flexible components of the linking element is formed by multiple closed rings connecting to each other.

10. The working ladder as claimed in claim 2, wherein
the second side rail of each one of the pair of ladder frames has a connecting segment connected to the connecting end of the corresponding foot stem; and
the abutting end of the foot stem of each one of the pair of ladder frames is connected to the first side rail of the corresponding ladder frame near the first distal end of the first side rail when the foot stem is located at the second position.

11. The working ladder as claimed in claim 10, wherein the abutting end of the foot stem of each one of the pair of ladder frames is selectively connected to the corresponding first side rail by a locking element.

12. The working ladder as claimed in claim 1, wherein the working ladder has an angle between the pair of ladder frames being less than 90 degrees when the supporting shaft is located at the supporting position.

13. The working ladder as claimed in claim 12, wherein the angle between the pair of ladder frames is 180 degrees when the supporting shaft is located at the storing position.
